(19) United States
(12) Patent Application Publication
(10) Pub. No.: US 2003/0182522 A1
(43) Pub. Date: Sep. 25, 2003

(54) SRAM compatible and page accessible memory device using dram cells and method for operating the same

(76) Inventors: In Sun Yoo, Icheon-si (KR); In Hong Kim, Seoul (KR)

Correspondence Address: CANTOR COLBURN, LLP, 55 GRIFFIN ROAD SOUTH, BLOOMFIELD, CT, 06002

(21) Appl. No.: 10/190,270

(22) Filed: Jul. 3, 2002

(30) Foreign Application Priority Data
Mar. 22, 2002 (KR) 2002-0015705

(51) Int. Cl. G06F 12/00

(52) U.S. Cl. 711/156; 711/106; 711/154

(57) ABSTRACT

An SRAM compatible and page accessible memory device using DRAM cells, and a method for operating the same. The semiconductor memory device is implemented by DRAM cells and performs a refresh operation internally, but externally operates as a conventional SRAM. The semiconductor memory device includes a memory array; an address input unit for receiving word addresses and page addresses; an address detection unit generating a page address transition detection signal in response to a transition of at least one page address, and generating a word address transition detection signal in response to a transition of at least one word address; and a memory array control unit for controlling a page access operation of the memory array. The memory array control unit controls the semiconductor memory device to enter into a normal access state responsive to the page address transition detection signal, and controls the semiconductor memory device to perform the page access operation for changing the column selected by the column selection means in response to the word address transition detection signal, with maintaining the word line in the activation state.

### BACKGROUND OF THE INVENTION

1. Field of the Invention

The invention relates to a semiconductor memory device, and more particularly, to a memory device, which has dynamic random access memory (DRAM) cells and is compatible with a static random access memory (SRAM), and a method for operating the same.

2. Description of the Related Art

Generally, a random access memory (RAM) of a semiconductor memory device is classified as either an SRAM or a DRAM. The general RAM includes a memory array having a plurality of unit memory cells arranged in the crossed point in matrix, and a peripheral circuitry for controlling data input/data output to/from the unit memory cells. In SRAM, the unit memory cell for storing one-bit data is implemented by four (4) transistors cross-coupled as a latch and two (2) transistors serving as transfer gates. That is, since data is stored in the unit memory cells of the latch, a refresh operation is not required for retention of the stored data in the SRAM. Also, the SRAM has high speed operation and low power consumption, compared with the DRAM.

However, since the unit memory cell of the SRAM is implemented by six (6) transistors, it requires a larger space than that of the DRAM implemented by one (1) transistor and one (1) capacitor. Therefore, for manufacturing memory devices of the same capacity, a required space for the SRAM is approximately 6 to 10 times larger than that for the DRAM. So, the manufacturing cost for the SRAM is increased, compared with the DRAM. The SRAM may be replaced by the DRAM in order to reduce the manufacturing cost. But, in this case, a DRAM controller is additionally required for periodic refresh operation. Therefore, the performance of the system itself may be deteriorated due to low-speed operation and the periodic refresh operation of the DRAM.

To overcome the above-mentioned disadvantages of the DRAM and the SRAM, a variety of modified SRAMs using the DRAM cells have been introduced. One of them is a memory device implemented with a multi-bank DRAM and an SRAM cache. The memory device is compatible with a conventional SRAM by nonexposing a refresh operation to an external.

The memory device is compatible with a synchronous SRAM requiring externally input clocks, but cannot be compatible with an asynchronous SRAM. Thus, it is difficult to apply this type of memory device to a low power asynchronous SRAM for mobile equipment or the like.

Alternatively, a memory device having two times internal DRAM access periods in one external SRAM access period can be used. That is, the memory device becomes in a reserved state for performing a refresh operation of the DRAM cell during one internal DRAM access period and then, performs an actual access operation of the DRAM cell during another internal DRAM access period.

However, it is difficult to make a memory device for performing a page access operation as well, which successively inputs/outputs data to/from unit memory cells arranged in different columns intersecting a row, during activation of a word line for selecting a column in the memory array.

### SUMMARY OF THE INVENTION

To overcome the above disadvantages, the invention provides an SRAM compatible memory device using DRAM cells and being able to perform a page access operation.

The invention also provides a method for operating the SRAM compatible memory device using DRAM cells.

In one aspect, a semiconductor memory device of the invention has a memory array including a plurality of memory cells arranged in rows and columns, and can be interfaced with an external system. Each memory cell requires a refresh operation for retention of data stored within a predetermined refresh period. The external system provides row selection addresses, for selecting a row in the memory array, and column selection addresses, for selecting a column in the memory array, at a substantially same time. And, a word line is activated for selecting the row, and a column selection means is selected for selecting the column. And then, the data is inputted/outputted to/from the selected memory cell. Also, the semiconductor memory device includes the memory array, an address input unit, an address detection unit and a memory array control unit. The address input unit receives page addressees and word addresses. The word addresses consist of a portion or all of the column selection addresses, and the page addresses consist of the row selection addresses and the remaining portion of the column selection addresses. The address detection unit generates a page address transition detection signal in response to the transition of the page addresses, and generates a word address transition detection signal in response to the transition of the word addresses. The memory array control unit controls a page access operation of the memory array. The memory array control unit controls the semiconductor memory device to enter into the normal access state, responding to the page address transition detection signal. And, the memory array control unit controls the semiconductor memory device to perform the page access operation for changing the selected column in response to the word address transition detection signal, with maintaining the activation of the word line selecting the row.

In another aspect, a method for driving the semiconductor memory device includes (a) receiving page addresses and word addresses, wherein the word addresses consist of a portion or all of the column selection addresses and the page addresses consist of the row selection addresses and the remaining portion of the column selection addresses; (b) entering into the normal access state in response to a page address transition; and (c) performing a page access operation for changing the column selected in response to a word address transition after the activation of the word line, with maintaining the activation state of the word line.

According to the semiconductor memory device and the method for operating the same, the memory device using DRAM cells is compatible with an SRAM and able to perform the page access operation.

### BRIEF DESCRIPTION OF THE DRAWINGS

The foregoing and further features and advantages of the invention will become more apparent from the following description and the accompanying drawings, in which the same reference numerals indicate the same or corresponding parts:

FIG. 1 is a block diagram showing a memory device according to one exemplary embodiment of the invention;

FIG. 2 is a circuit diagram illustrating a unit memory cell in a memory array shown in FIG. 1;

FIG. 3 is a timing diagram for explaining main signals generated during an access operation of the memory device; and

FIG. 4 is a state transition diagram for explaining state transition in the memory device.

### DESCRIPTION OF THE INVENTION

In a memory device according to the invention, DRAM cells are implemented and a refresh operation is performed internally. But, duration for the refresh operation is not allocated in operation specification like as the general SRAM. Also, the memory device of the invention externally operates as the conventional SRAM without requiring additional signals for controlling the refresh operation.

The memory device has several states including a REFRESH state, a RESERVED state, an ACCESS state and an IDLE state.

In the REFRESH state, the memory device activates a word line and reads out data from the memory cells connected to the activated word line. And then the data is amplified and restored to the memory cells.

In the RESERVED state, the REFRESH state can be allocated for the memory device. That is, the RESERVED state is transited into the REFRESH state, in response to a refresh operation signal provided from a refresh timer.

In the ACCESS state, write/read operations can be performed for the memory cells in the memory array. The ACCESS state includes a page (PAGE) access state. In the PAGE access state, a PAGE access operation can be performed. In the PAGE access operation, two or more columns can be successively selected by external input addresses and the data is read out or written, while the word line is maintained in the activated state. In the PAGE access operation, the access time can be reduced for the next access. The PAGE access state throughout the specification and claims means a state in which the word line is activated. On the other hand, for convenience of explanation, the other state of the ACCESS state except the PAGE access state is designated as a normal (NORMAL) access state.

In the IDLE state, a chip selection signal is not yet activated, so that the memory device itself is disabled.

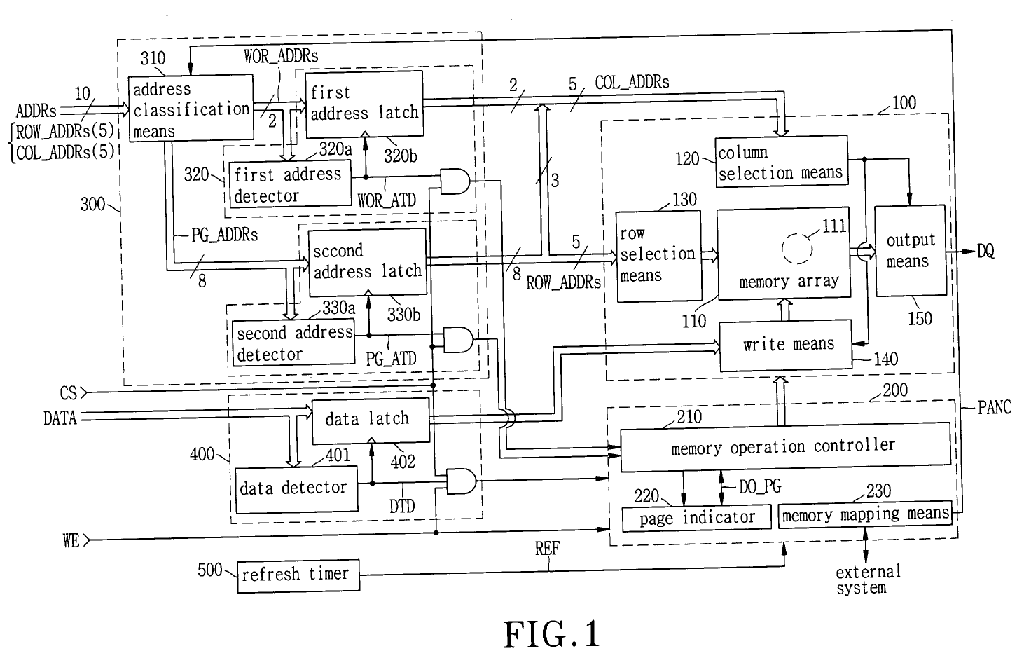

FIG. 1 is a block diagram showing a semiconductor memory device according to one exemplary embodiment of the invention. The semiconductor memory device includes a data storing unit 100, a memory array controller 200, an address input unit 300, a data input unit 400 and a refresh timer 500.

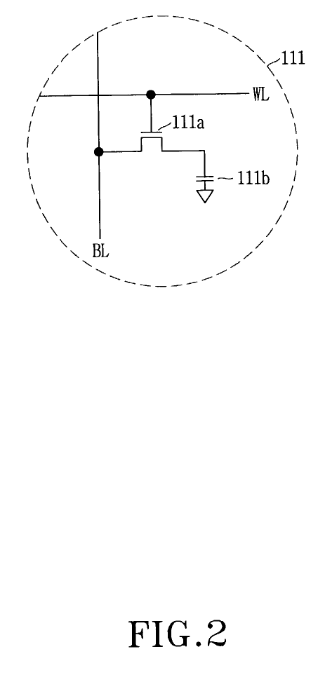

The data storing unit 100 has a memory array 110 including a plurality of memory cells 111 arranged in a row and column type matrix. Each memory cell 111 requires the refresh operation for retention of data stored therein, within a predetermined refresh period. A DRAM cell is a typical example of the memory cell 111. Therefore, for convenience of explanation, the memory cell 111 is designated as a DRAM cell in this specification. As shown in FIG. 2, the DRAM cell can be implemented by a transfer transistor 111a to be gated by a word line (WL) and a capacitor 111b for storing data.

The address input unit 300 receives external input addresses (ADDRs), and classifies them as word addresses (WOR_ADDRs) and page addresses (PG_ADDRs). And, the address input unit 300 provides a word address transition detection signal (WOR_ATD) and a page address transition detection signal (PG_ATD) to the memory cell controller 200. The WOR_ATD is generated as a pulse in response to transition of the WOR_ADDRs, and the PG_ATD is generated as a pulse in response to transition of the PG_ADDRs.

Also, since the memory device of the invention operates as the conventional SRAM as above-mentioned, the address input unit 300 receives row selecting addresses and column selecting addresses at a substantially same time. Therefore, the row selecting addresses and the column selecting addresses are not externally classified. But, for convenience of explanation, the addresses selecting the row are designated as row selection addresses (ROW_ADDRs), and the addresses selecting the column are designated as column selection addresses (COL_ADDRs).

The address input unit 300 includes an address classification means 310, a word address detection means 320 and a page address detection means 330. The address classification means 310 classifies the ADDRs as the WOR_ADDRs and the PG_ADDRs. The WOR_ADDRs consist of a portion or all of the COL_ADDRs. The PG_ADDRs consist of the ROW_ADDRs and the remaining portion of the COL_ADDRs except the WOR_ADDRs. For example, if the memory device has 2⁵×2⁵ DRAM cells 111 and page depth of four (4), the number of each of the COL_ADDRs and the ROW_ADDRs is five (5) and the number of the ADDRs is ten (10). The page depth means the number of the PAGE access operations which are successively performed. Since the page depth is four (4), the number of the WOR_ADDRs is two (2), and the number of the PG_ADDRs is eight (8).

The word address detection means 320 detects the transition of the WOR_ADDRs, and transfers the WOR_ADDRs to a column selection means 120. The word address detection means 320 includes a first address detector 320a and a first address latch 320b. When the WOR_ADDR transition is detected, the first address detector 320a generates the WOR_ATD. Then, the WOR_ATD is provided to the memory array controller 200, when a chip selection signal (CS) is activated to a logic “high”. The CS enables the memory device. The CS is externally provided. And, the first address latch 320b latches the WOR_ADDRs and supplies the same to the column selection means 120 in response to the WOR_ATD.

The page address detection means 330 detects the transition of the PG_ADDRs, and transfers the PG_ADDRs to the column selection means 120 and a row selection means 130. The page address detection means 330 includes a second address detector 330a and a second address latch 330b. The second address detector 330a generates the PG_ATD, when the PG_ADDRs' transition is detected. Then, the PG_ATD is provided to the memory array controller 200 when the CS is activated to a logic “high”. And, the second address latch 330b latches the PG_ADDRs, and supplies the same to the column selection means 120 and the row selection means 130, in response to the PG_ATD. In this case, the PG_ADDRs, which are supplied to the column selection means 120, are not the WOR_ADDRs but the COL_ADDRs. And the PG_ADDRs, which are supplied to the row selection means 130, consist of the ROW_ADDRs.

Consequently, the COL_ADDRs are supplied to the column selection means 120, and the ROW_ADDRs are supplied to the row selection means 130.

In the embodiment shown in FIG. 1, ten (10) the ADDRs are classified as two (2) the WOR_ADDRs and eight (8) the PG_ADDRs, in the address classification means 310. But, the number of the WOR_ADDRs can be modulated, according to the page depth. For example, if the page depth is eight (8), the number of the WOR_ADDRs is modulated to three (3). In this case, the number of the WOR_ADDRs is controlled by a page depth control signal (PANC), which is provided from a memory mapping means 230 in the memory array controller 200.

The column selection means 120 decodes the COL_ADDRs, thereby selecting a column of the memory array 110. That is, the COL_ADDRs, which are decoded by the column selection means 120, control a write means 140 and an output means 150 so that the column of the memory array 110 is selected. And, the row selection means 130 decodes the ROW_ADDRs, thereby selecting a row of the memory array 110. That is, the ROW_ADDRs, which are decoded by the row selection means 130, activate a word line for the row to be selected, so that the row of the memory array 110 is selected.

The data input unit 400 receives an input data (DATA) and provides the received DATA to the write means 140. The data input unit 400 includes a data detector 401 and a data latch 402. The data detector 401 generates a data transition detection signal (DTD) when a DATA transition is detected. And, when the CS and a write enable signal (WE) are activated to a logic “high”, the DTD is provided to the memory array controller 200. The WE controls the write/read operations of the memory device. When the WE is activated to a logic “high”, the memory device of the invention is able to perform the write operation. On the other hand, when the WE is non-activated to a logic “low”, the memory device is able to perform the read operation. The data latch 402 latches the DATA and supplies the same to the write means 140 in response to the DTD.

The DATA is latched by the data detector 401 and the data latch 402 so that the memory device is able to perform the PAGE access operation for the duration of the write (WRITE) operation, even if an additional control signal is not externally inputted.

The refresh timer 500 supplies the memory array controller 200 with a refresh request signal (REF) to be activated every predetermined refresh period, so that the DRAM cells 111 of the memory array 110 perform the refresh operation.

The memory array controller 200 includes a memory operation controller 210, a page indicator 220 and the memory mapping means 230.

The memory operation controller 210 controls operations of the memory array 110 such as the PAGE access operation and so forth. The page indicator 220 supplies a page indication signal (DO_PG) to the memory operation controller 210. The DO_PG is activated in a predetermined delay duration from generation of the PG_ATD or the WOR_ATD. The memory mapping means 230 communicates with an external system, and generates the PANC for controlling the page depth.

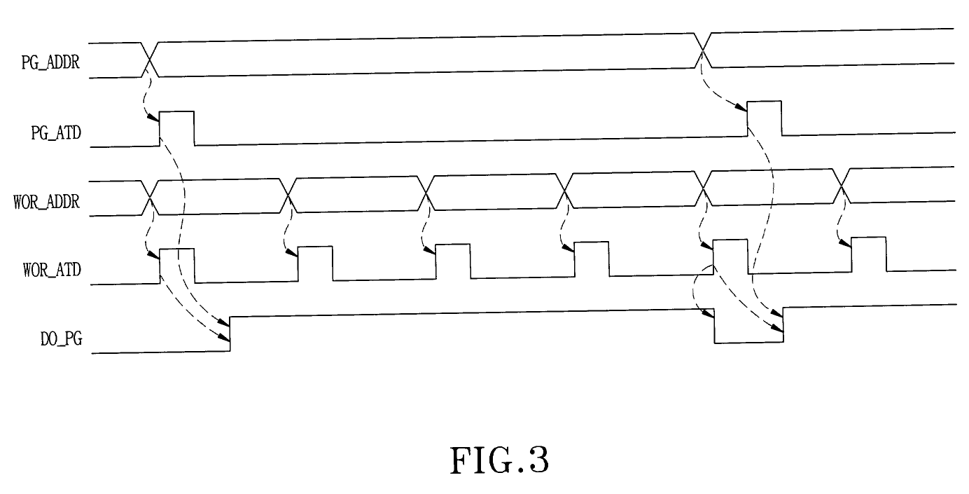

FIG. 3 is a timing diagram for explaining main signals generated during an access operation of the memory device. Referring to FIG. 3, the CS is logic “high” and the WE is logic “low”. The PG_ATD is activated in response to the PG_ADDR transition, and the WOR_ATD is activated in response to the WOR_ADDR transition.

The DO_PG is activated in the delay duration from generation of the PG_ATD or the WOR_ATD. And, the DO_PG is non-activated to a logic “low” by the PG_ATD. Therefore, when the PG_ATD is activated, the DO_PG becomes non-activated with a predetermined pulse width and thereafter is activated again. And, when the WOR_ATD is activated in the activation state of the DO_PG, the DO_PG continuously holds the activation state.

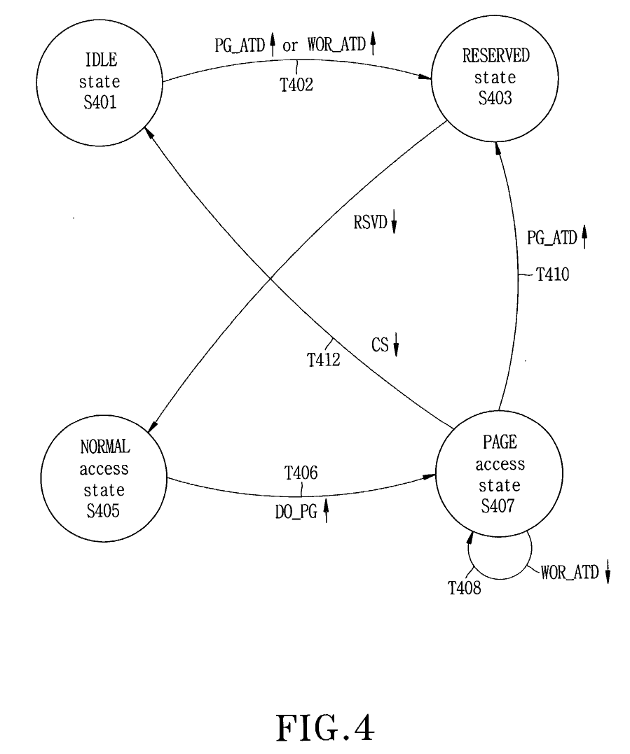

FIG. 4 is a state transition diagram for explaining state transition in the memory device. In the state transition diagram shown in FIG. 4, entry into the other states or operation in the other states except the IDLE state S401 is described on the assumption that the CS is activated to a logic “high”.

When either the PG_ATD or the WOR_ATD becomes activated to a logic “high” in the IDLE state S401, the memory device enters into the RESERVED state S403, at transition T402. Then, after a predetermined first duration from the entry into the RESERVED state S403 (that is, a reservation duration) (RSVD↓), the memory device enters into the NORMAL access state S405, at transition T404. Preferably, the first duration is defined as a time interval to access the DRAM cell 111 of the memory array 110 from the entry into the NORMAL access state.

After a predetermined second duration from the NORMAL access state S405, the DO_PG becomes activated to a logic “high”. Then, the memory device enters into the PAGE access state S407 responsive to activation of the DO_PG, at transition T406. The second duration means a time interval between the entry into the NORMAL access state S405 and the activation of a signal for driving the word line for selecting the row in the memory array 110.

In the PAGE access state S407, even if the WOR_ATD is activated to a logic “high”, the memory device retains the PAGE access state S407, at transition T408. On the other hand, when the PG_ATD is activated to a logic “high” in the PAGE access state S407, the memory device returns to the RESERVED state S403, at transition T410. Also, when the CS is non-activated to a logic “low” in the PAGE access state S407, the memory device returns to the IDLE state S401, at transition T412.

According to the memory device and the method for operating the same in the invention, after the second duration from the entry into the NORMAL access state, the DO_PG is activated and then the memory device enters into the PAGE access state. And, even if the WOR_ADDRs are transited in the activation state of the DO_PG, the memory device performs the page access operation. Thereafter, when the PG_ADDRs are transited, the memory device returns to the RESERVED state again and performs the normal access operation.

While this invention has been particularly shown and described with reference to the embodiment thereof, it will be understood by those skilled in the art that various changes and equivalents may be made without departing from the spirit and scope of the invention. For example, in the embodiment, the RESERVED state being able to perform the refresh operation or the REFRESH state occurs before the read or the write operation. But, in another embodiment, it is obvious to those skilled in the art that the REFRESH state can occur after the read or the write operation. Therefore, it is intended that the invention not be limited to the particular embodiment disclosed as the best mode contemplated for carrying out this invention, but that the invention will include all embodiments within the scope of the appended claims.

What is claimed is:

1. A page access operation method of a semiconductor memory device having a memory array and being able to be interfaced with an external system, the memory array including memory cells arranged in rows and columns, each memory cell requiring a refresh operation for retention of stored data within a predetermined refresh period, the external system providing row selection addresses and column selection addresses at a substantially same time, the semiconductor memory device performing read/write operations of the memory cell selected by enabling a column selection means and activating a word line to select a row, in a normal access state, the method comprising the steps of:
(a) receiving page addresses and word addresses, wherein the word addresses consist of a portion or all of the column selection addresses and the page addresses consist of the row selection addresses and the remaining portion of the column selection addresses;
(b) entering into the normal access state in response to a transition of page addresses; and
(c) performing a page access operation, the page access operation changing the column selected by the column selection means in response to a transition of the word addresses after the activation of the word line, with maintaining the activation state of the word line.

2. The page access operation method in accordance with claim 1, wherein the step (b) includes:
(b1) entering into a reserved state in which the refresh operation of the memory cells is performed in response to the page address transition; and
(b2) entering into the normal access state after a first duration from the entry into the reserved state.

3. The page access operation method in accordance with claim 2, wherein the step (c) includes:
(c1) entering into a page access state after a second duration from the entry into the normal access state; and
(c2) performing the page access operation in response to the transition of the word addresses generated during the page access state.

4. The page access operation method in accordance with claim 3, wherein the step (c1) includes:
(c11) generating a page indication signal after the second duration from the entry into the normal access state; and
(c12) entering into the page access state in response to the page indication signal.

5. The page access operation method in accordance with claim 4, wherein the second duration is a time interval from the entry into the normal access state to the activation of a signal for driving the word line.

6. The page access operation method in accordance with claim 4, further comprising the step of classifying the column selection addresses as the page addresses and the word addresses.

7. The page access operation method in accordance with claim 6, further comprising the step of controlling the classification of the column selection addresses by an address classification signal.

8. The page access operation method in accordance with claim 3, further comprising the step of generating a data transition detection signal in response to a transition of an externally inputted data.

9. The page access operation method in accordance with claim 2, further comprising the step of generating a data transition detection signal in response to a transition of an externally inputted data.

10. The page access operation method in accordance with claim 1, further comprising the step of generating a data transition detection signal in response to a transition of an externally inputted data.

11. A semiconductor memory device having a memory array and being able to be interfaced with an external system, the memory array including memory cells arranged in rows and columns, each memory cell requiring a refresh operation for retention of stored data within a predetermined refresh period, the external system providing row selection addresses and column selection addresses at a substantially same time, the semiconductor memory device performing read/write operations of the memory cell selected by enabling a column selection means and activating a word line to select a row, in a normal access state, comprising:
an address input unit for receiving word addresses and page addresses, wherein the word addresses consist of a portion or all of the column selection addresses and the page addresses consist of the row selection addresses and the remaining portion of the column selection addresses;
an address detection unit for generating a page address transition detection signal in response to a transition of the page addresses, and generating a word address transition detection signal in response to a transition of the word addresses; and
a memory array control unit for controlling a page access operation of the memory array,
wherein the memory array control unit controls the semiconductor memory device to enter into the normal access state responsive to the page address transition detection signal, and controls the semiconductor memory device to perform the page access operation for changing the column selected by the column selection means in response to the word address transition detection signal, with maintaining the word line in the activation state.

12. The semiconductor memory device in accordance with claim 11, wherein the memory array control unit controls the semiconductor memory device to enter into a reserved state for performing the refresh operation responsive to the page address transition detection signal, and controls the semiconductor memory device to enter into the normal access state after a first duration from the entry into the reserved state.

13. The semiconductor memory device in accordance with claim 12, wherein the memory array control unit controls the semiconductor memory device to enter into a page access state after a second duration from the entry into the normal access state, and controls the semiconductor memory device to perform the page access operation in response to the word address transition generated in the page access state.

14. The semiconductor memory device in accordance with claim 13, wherein the memory array control unit includes a page indication means for generating a page indication signal after the second duration from the entry into the normal access state, and
wherein the semiconductor memory device is controlled to enter into the page access state responsive to the page indication signal.

15. The semiconductor memory device in accordance with claim 14, wherein the second duration is a time interval between the entry into the normal access state and the activation of a signal for driving the word line.

16. The semiconductor memory device in accordance with claim 15, wherein the address input unit includes an address classification means for classifying the column selection addresses as the page addresses and the word addresses.

17. The semiconductor memory device in accordance with claim 16, wherein the address classification means controls the number of the page addresses and the number of the word addresses, in response to an address classification signal externally inputted.

18. The semiconductor memory device in accordance with claim 13, further comprising a data input unit for generating a data detection signal in response to a transition of an externally inputted data.

19. The semiconductor memory device in accordance with claim 12, further comprising a data input unit for generating a data detection signal in response to a transition of an externally inputted data.

20. The semiconductor memory device in accordance with claim 11, further comprising a data input unit for generating a data detection signal in response to a transition of an externally inputted data.
